(19) United States
(12) Patent Application Publication
(10) Pub. No.: US 2025/0360600 A1
(43) Pub. Date: Nov. 27, 2025

(54) UNIVERSAL WORKPIECE HOLDING DEVICE

(71) Applicant: Kyle Disney, Arvada, CO (US)

(72) Inventor: Kyle Disney, Arvada, CO (US)

(21) Appl. No.: 19/211,906

(22) Filed: May 19, 2025

Related U.S. Application Data
(60) Provisional application No. 63/650,124, filed on May 21, 2024.

(51) Int. Cl. B25B 5/14

(52) U.S. Cl. CPC B25B 5/14

(57) ABSTRACT

A universal workpiece holding device is disclosed for securing a workpiece during precision machining. The device includes a securement member with a perimeter wall forming an internal floor. A stationary lip is positioned along at least a portion of the interior perimeter, partially overhanging the floor. At least one opening is formed through the perimeter wall, accommodating at least one clamping member. The clamping member is movable between an open position, allowing the workpiece to be inserted onto the floor beneath the stationary lip, and a closed position, where it presses against the workpiece to secure it. This configuration provides enhanced stability, minimizing unwanted movement during machining operations. The device allows for secure retention of various workpieces while maintaining accessibility for adjustments and removals. Its design supports high-precision manufacturing by reducing backlash and improving clamping efficiency, ensuring reliable workpiece e positioning in demanding machining environments.

### PRIORITY CLAIM

This application claims the priority filing benefit of U.S. Provisional Patent Application No. 63/650,124 filed May 21, 2024 for “Universal Workpiece Holding Device” of Kyle Disney, hereby incorporated by reference in its entirety as though fully set forth herein.

### BACKGROUND

Maintaining precise control over a workpiece during machining operations is critical to ensuring dimensional accuracy and consistency in manufactured components. As tolerances continue to tighten across industries such as aerospace, medical devices, and high-performance automotive engineering, the effectiveness of traditional workpiece holding methods becomes increasingly scrutinized. Conventional bolting, clamping, and straight jaw vises rely on static friction and mechanical force to restrain the workpiece. Under high cutting forces, rapid tool movement, or thermal expansion, these methods may introduce unwanted micro-movements. Even minor shifts during machining can lead to dimensional deviations that render the final product unusable, necessitating expensive material waste and rework.

Several factors contribute to the instability of traditional workpiece holding mechanisms. First, variations in material properties, such as surface roughness and hardness, affect the effectiveness of clamping forces. Soft or highly polished materials may experience gradual slippage under sustained machining forces, especially when lubricants or coolants are introduced into the environment. Additionally, machining forces exert dynamic loads on the workpiece, resulting in vibration or transient shifts that exceed permissible tolerances. Straight jaw vises and basic clamping systems may not account for these secondary forces, allowing subtle movement that accumulates into measurable errors in the final product.

Simple vices often leverage high-friction contact surfaces and precision-aligned gripping jaws that counteract machining-induced forces. While bolting and basic vise mechanisms remain viable for less stringent applications, specialized machining processes necessitate solutions that eliminate unwanted movement at the smallest level.

Hydraulic and pneumatic vises offer adaptable clamping forces that compensate for material expansion and contraction during machining cycles. Additionally, engineered vises featuring automated monitoring systems can actively adjust holding force in real time, mitigating risks associated with dynamic machining conditions. However, these solutions can be cost prohibitive, particularly for smaller machine shops.

### BRIEF DESCRIPTION OF THE DRAWINGS

FIG. 1 is an isometric view of an example universal workpiece holding device.

FIG. 2 shows isometric views of the spring and bolt shown in FIG. 1.

FIG. 3 shows isometric views of the clamping member shown in FIG. 1.

FIG. 4 shows side views of the clamping member corresponding to FIG. 3.

FIG. 5 illustrates assembly of the universal workpiece holding device shown in FIG. 1.

FIG. 6 shows the universal workpiece holding device corresponding to the illustration of FIG. 5 in a clamped configuration.

FIG. 7 is an isometric view of a bottom portion of a workpiece.

FIG. 8 is an isometric view of two example universal workpiece holding devices configured to hold a workpiece.

FIG. 9 is an isometric view of a bottom portion of the workpiece shown in FIG. 8.

FIG. 10 is an isometric view of example universal workpiece holding devices as these can be connected together to form any of a variety of different systems.

FIG. 11 is an isometric view of another example universal workpiece holding device.

FIG. 12 is an isometric view of another example universal workpiece holding device.

FIG. 13 shows top and side views of the example universal workpiece holding device shown in FIG. 12.

FIG. 14 is an isometric view of another example universal workpiece holding device.

FIG. 15 is an isometric view of another example universal workpiece holding device.

FIG. 16 shows isometric views of another example universal workpiece holding device.

FIG. 17 is an isometric view of another example universal workpiece holding device.

FIG. 18 is an isometric view of another example universal workpiece holding device.

FIG. 19 is an isometric view of another example universal workpiece holding device.

FIG. 20 is an isometric view of another example universal workpiece holding device.

FIG. 21 is an isometric view of another example universal workpiece holding device.

FIG. 22 is an isometric view of another example universal workpiece holding device.

FIG. 23 is an isometric view of another example universal workpiece holding device.

### DETAILED DESCRIPTION

As machining techniques advance, the integration of adaptive workholding solutions plays an increasingly vital role in ensuring product quality and performance across diverse engineering applications. Through innovation, manufacturers can achieve higher yields, reduce material waste, and improve reliability in high-precision components.

Given the stringent requirements imposed by modern precision machining, workpiece holding technology must continuously evolve to align with industry demands. As precision requirements continue to evolve, the development of next-generation workholding solutions remains an important aspect of advancing manufacturing efficiency and component reliability. To address these challenges, advanced workpiece holders must incorporate features designed to maximize grip and stability, and to minimize movement of the workpiece.

A universal workpiece holding device is disclosed as it may be implemented for machining of precision parts. In an example, the universal workpiece holding device includes precision and repeatable locating components that provide a secure hold on parts during manufacturing operations. The universal workpiece holding device disclosed herein eliminates the need to create custom fixtures to manufacture parts. It also allows for repeatability in machining.

The clamping member has an inward oriented overhang or “half dovetail” to engage with a complimentary edge formed on workpiece when the workpiece is inserted onto the floor of the securement member to secure the workpiece to the securement member.

In an example, the clamping member pulls up against the workpiece (e.g., by the angle of the half-dovetail) when tightened to create multiple contact surfaces which help prevent loosening such as from vibration during the machining process. The clamping member precisely locates the workpiece in the workpiece holding device when pushed together by the clamping member(s).

In an example, the workpiece holding device provides a true zero backlash grip, ensuring stability during precision machining operations. This eliminates micro-movements that can lead to dimensional inaccuracies, allowing for consistent quality in high-tolerance manufacturing. The zero backlash grip mechanism is particularly advantageous in environments where vibration, tool forces, or material expansion could otherwise compromise the integrity of the workpiece's position.

The term “zero backlash grip” in the context of the device disclosed herein refers to a clamping mechanism that eliminates any (or nearly all) unintended movement or play between the jaws when securing a workpiece. In traditional vices, a small amount of backlash (often caused by mechanical tolerances or wear) can result in slight movement when force is applied. A zero backlash design ensures that once the jaws engage the workpiece, there is no slack or unintended shifting, leading to higher precision and stability. This is particularly useful in machining and precision work, where even minor movement can affect accuracy. Zero backlash can be achieved through preloaded mechanisms, anti-backlash screws, and/or specialized grip configurations such as those disclosed herein, that maintain constant contact without excess play.

In an example, one or more half-dovetails can be cut into the bottom of other workpiece holding devices to make quick change vise toppers, facilitating rapid setup and interchangeability. This allows machinists to quickly swap vise configurations without requiring additional alignment or recalibration, thereby increasing workflow efficiency. The half-dovetail integration provides secure retention while maintaining the flexibility needed for adapting to different workpiece geometries and machining requirements.

The clamping member has an inward oriented overhang or “half dovetail” to engage with a complimentary edge formed on a workpiece when the workpiece is inserted onto the floor of the securement member to secure the workpiece to the securement member.

In an example, a straight workpiece holding device can be utilized in conjunction with a fixed workpiece holding device to permit adjustments and/or movement and/or accommodate larger workpieces. This setup enables controlled positioning changes, allowing the workpiece to be repositioned without complete disengagement from the holding device. Such a configuration can be beneficial in operations where progressive adjustments are needed during multi-stage machining processes.

In an example, multiple straight workpiece holding devices can be stacked together to form modular workpiece holding solutions, offering scalability and customization based on specific machining needs. By stacking individual units, machinists can adjust clamping forces and configure holding arrangements that suit complex geometries or oversized components. This modular approach enhances adaptability and expands the range of workpieces that can be securely fixed during machining.

In an example, the universal workpiece holding device provides quick change options to be swapped in a much quicker and more accurate manner while maintaining an equal or stronger mounting solution. This streamlines the machining process by minimizing downtime associated with workpiece transitions. With high precision mounting, machinists can achieve repeatable setups, ensuring consistent positioning with each use.

In an example, the universal workpiece holding device can be implemented for ready replacement and/or interchangeability of wear or maintenance parts of machinery, thereby reducing operational disruptions. Components subject to high wear, such as clamping jaws or grip surfaces, can be swapped out without requiring complete system replacement. This modularity extends the lifespan of the workpiece holding device while minimizing maintenance costs.

The ability of the universal workpiece holding device to provide precise holding stability enables improved efficiency in industrial applications requiring high load-bearing capability. In an example, the universal workpiece holding device can be utilized for heavy industrial machinery and earth-moving equipment, where robust clamping mechanisms are essential. The device can withstand extreme forces and environmental conditions, ensuring secure retention of large and heavy components.

In an example, the universal workpiece holding device can be implemented for tractor or heavy machinery buckets, attachments, drill bit heads, and other accessories for tractors or heavy machinery, broadening its application beyond standard machining tasks. The versatility of the device allows for secure retention of interchangeable parts in various industries, including construction, mining, and manufacturing. By providing a repeatable and strong mounting solution, it enhances equipment longevity and operational precision.

In another example, the universal workpiece holding device enables robots to hold onto tooling and workpieces with an easily changeable and repeatable system, facilitating automation in manufacturing environments. This feature enhances robotic machining accuracy by providing secure grip and reliable repositioning capabilities. The adaptability of the universal workpiece holding device enables seamless transitions between different tooling setups, optimizing production speed and precision.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

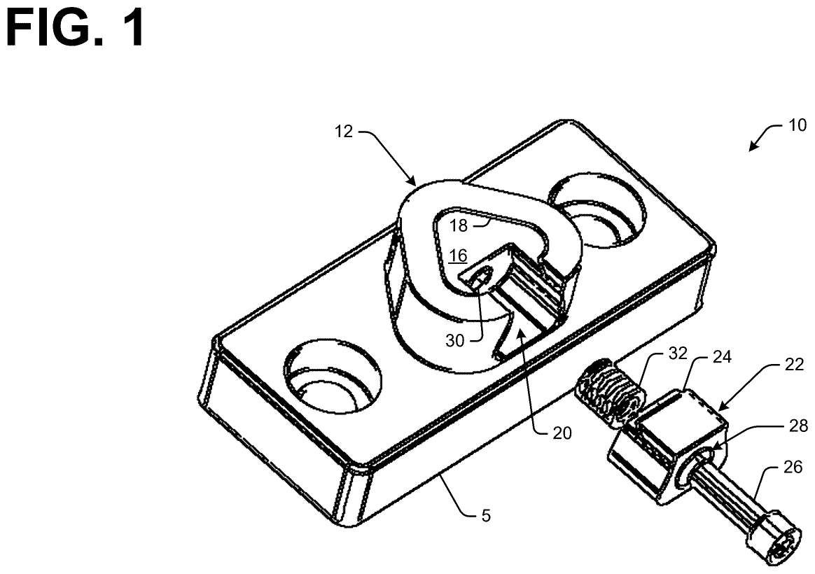

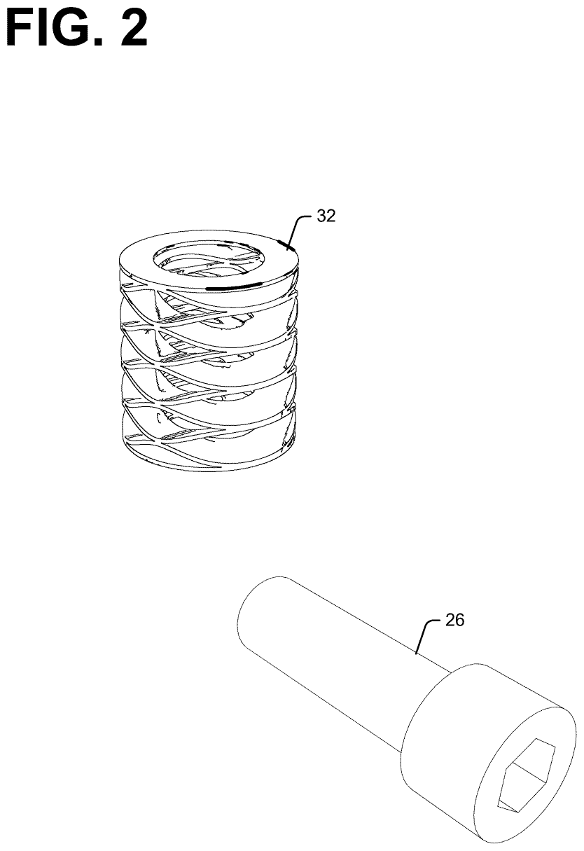

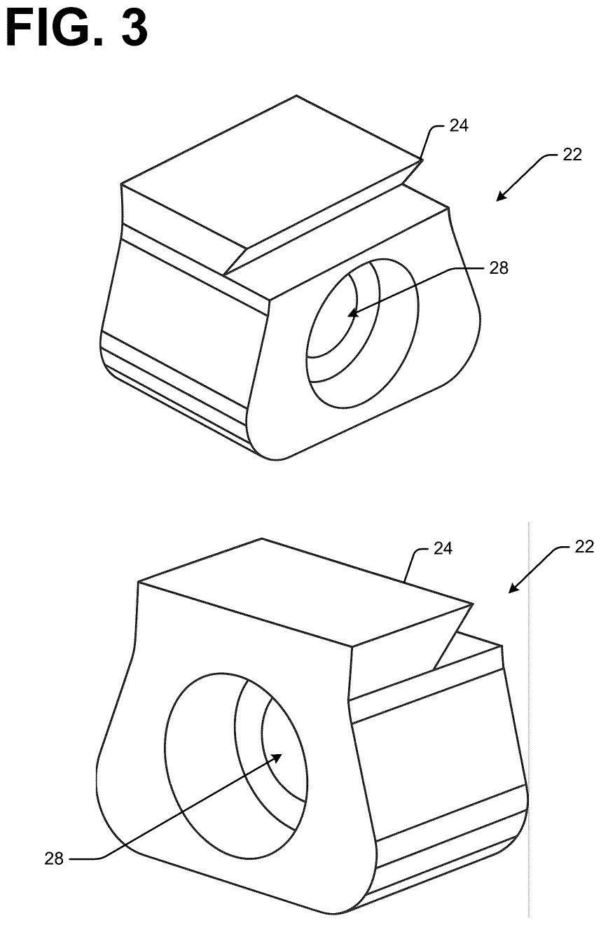

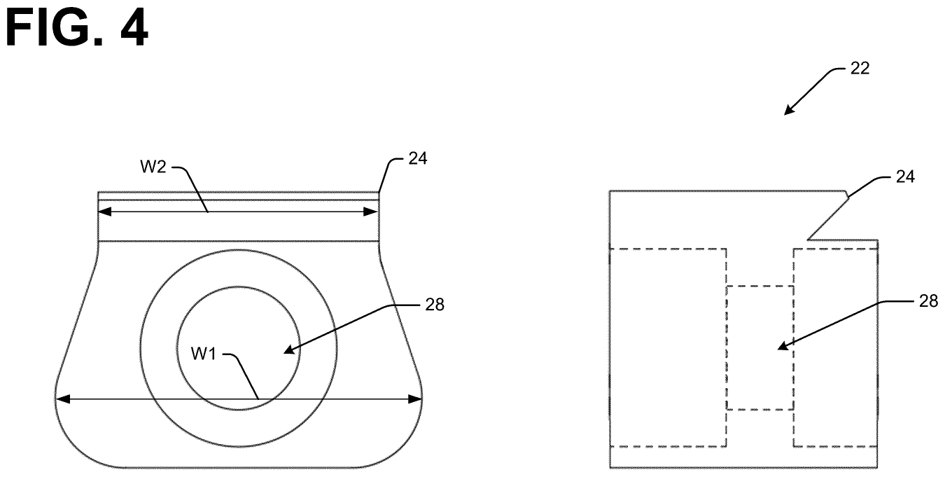

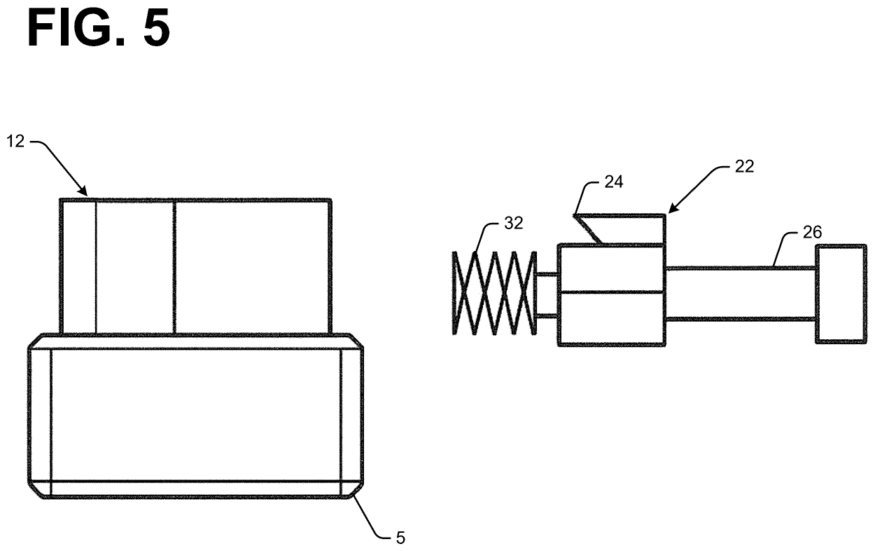

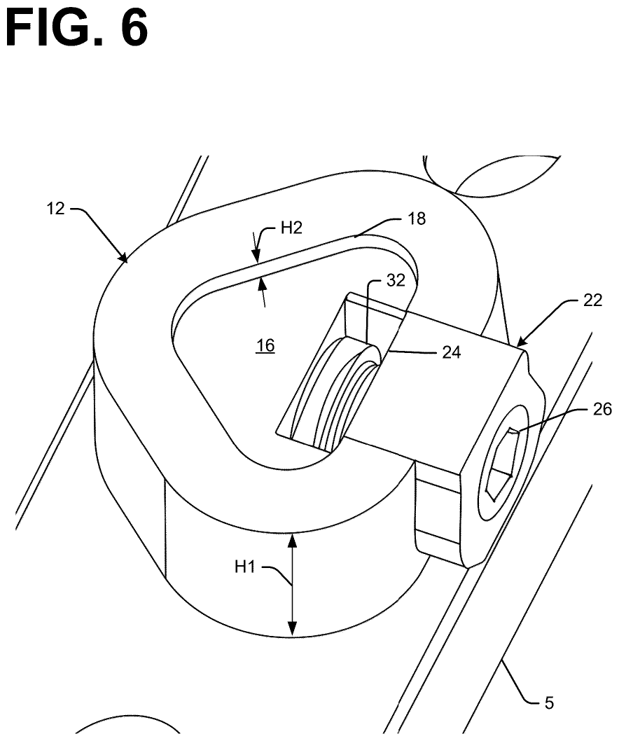

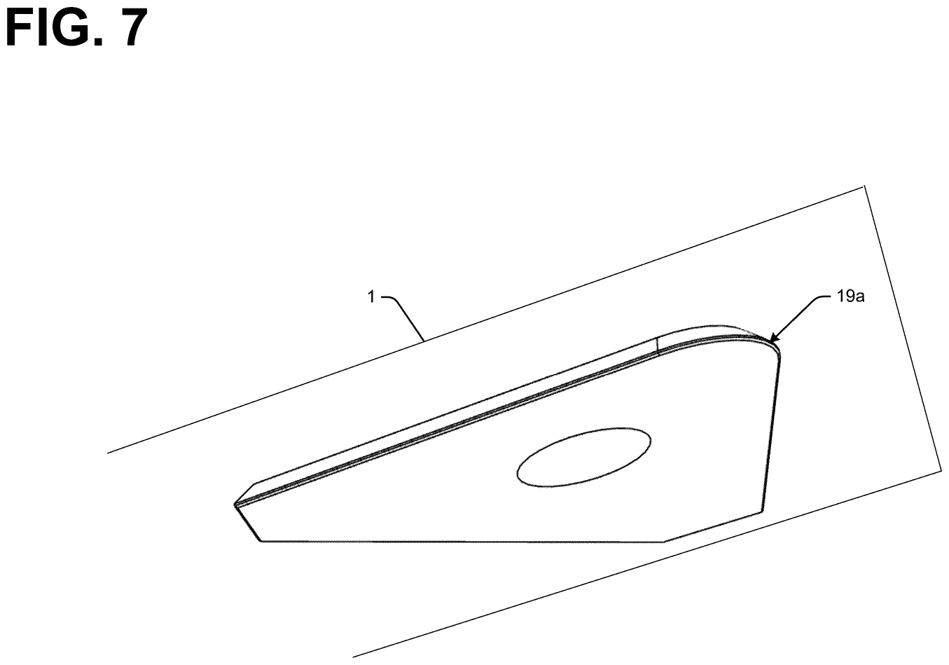

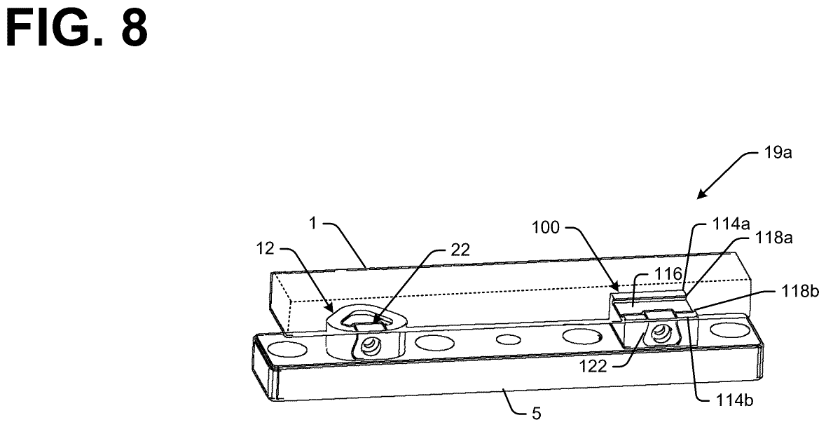

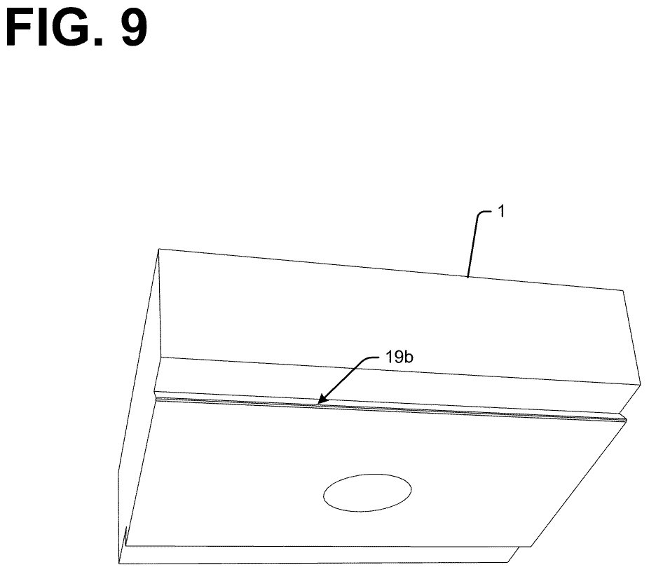

FIG. 1 is an isometric view of an example universal workpiece holding device 10. FIG. 2 shows isometric views of the spring and bolt shown in FIG. 1. FIG. 3 shows isometric views of the clamping member shown in FIG. 1. FIG. 4 shows side views of the clamping member corresponding to FIG. 3. FIG. 5 illustrates assembly of the universal workpiece holding device shown in FIG. 1. FIG. 6 shows the universal workpiece holding device corresponding to the illustration of FIG. 5 in a clamped configuration. FIG. 7 is an isometric view of a bottom portion of a workpiece 1. FIG. 8 is an isometric view of two example universal workpiece holding devices configured to hold a workpiece. FIG. 9 is an isometric view of a bottom portion of the workpiece shown in FIG. 8.

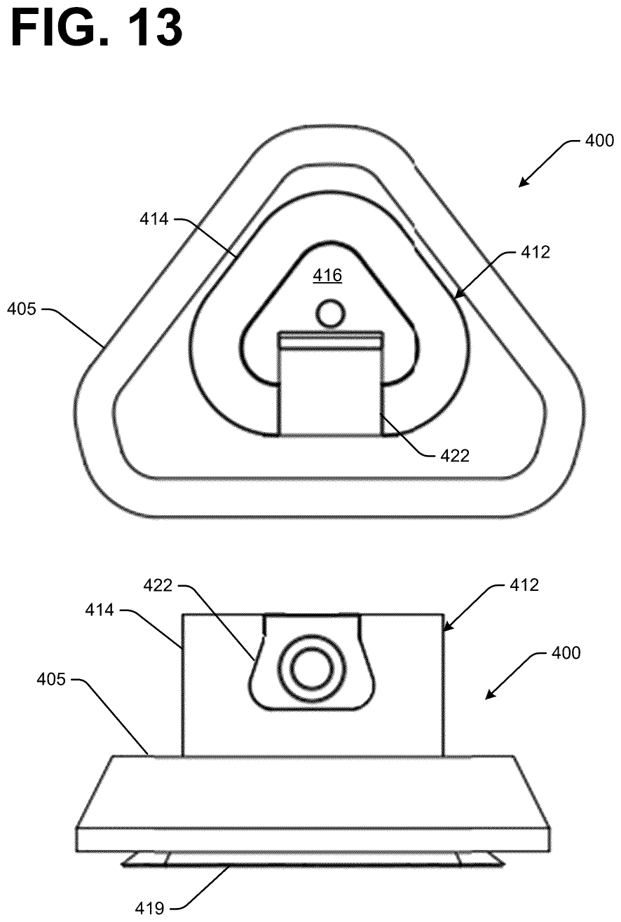

It is noted that 100, 200, 300, 400, etc. series reference numbers are used to refer to like components, without describing or referencing those components again herein. For example, perimeter wall 414 in FIG. 13 corresponds to perimeter wall 14 described with reference to FIG. 1, but for the embodiment 400 shown in FIG. 13.

An example universal workpiece holding device 10 is configured to provide secure retention of a workpiece (e.g., workpiece 1 shown in FIG. 8) during precision machining operations. A securement member 12 (see, e.g., FIGS. 1, 5, 6, and 8) is the primary structure for holding the workpiece 1. The securement member 12 maintains stability and rigidity, ensuring that machining forces do not compromise the alignment or position of the workpiece 1 during processing. The securement member 12 is the foundation upon which all other components interact, providing a controlled environment for high-precision manufacturing.

The securement member 12 includes at least one perimeter wall 14 at least partially encircling the upper portion of the securement member 12 (see, e.g., FIGS. 1 and 6). The perimeter wall 14 not only defines the boundary of the universal workpiece holding device 10 but also contributes to the securement of the workpiece 1. An interior floor 16 is formed within the perimeter wall 14. The floor 16 offers a surface on which the workpiece 1 rests. The floor 16 ensures proper placement and stability, reducing the likelihood of unintended movement during machining. The interaction between the floor 16 and the perimeter wall 14 creates a controlled positioning system that aids in precision alignment of the workpiece 1 relative to the universal workpiece holding device 10.

In an example, a stationary lip 18 (see, e.g., FIGS. 1 and 6) is incorporated along at least a portion of the inner side of the perimeter wall 14 of the securement member 12, partially overhanging the floor. When the workpiece 1 is inserted onto the floor 16, it is partially positioned beneath the stationary lip 18, preventing vertical displacement and minimizing unwanted movement. This enhances the stability of the workpiece 1, allowing for consistent machining results with minimal deviation.

At least one opening 20 (see, e.g., FIGS. 1 and 6) is formed through the perimeter wall 14 to accommodate insertion of the workpiece 1 onto the floor 16, followed by insertion of a clamping member 22 into the opening 20. The opening 20 provides an entry point for both the workpiece and the clamping member 22, which operates between an open position (e.g., shown in FIG. 1) and a closed position (e.g., shown in FIG. 6). The clamping member 22 slides within the opening 20, allowing for adjustable securing of the workpiece 1 within the perimeter wall 14. In the open position, the clamping member 22 retracts, permitting the workpiece 1 to be placed onto the floor 16 of the securement member 12. In the closed position, the clamping member 22 moves against the workpiece 1, applying sufficient force to press the workpiece 1 against the perimeter wall 14 and hold the workpiece 1 in place with little to no backlash.

The interaction (see, e.g., FIGS. 5 and 6) between the clamping member 22 and the stationary lip 18 ensures that the workpiece 1 remains securely positioned within the perimeter wall 14 of the securement member 12 throughout the machining process. By locking the workpiece 1 at least partially beneath the stationary lip 18 while applying lateral force through the clamping member 22, the universal workpiece holding device 10 mitigates unintended shifts that could compromise machining accuracy. This arrangement provides a stable, repeatable solution for holding workpieces 1 in precision applications, optimizing both efficiency and quality in high-precision manufacturing environments.

In an example, the stationary lip 18 extends over the floor 16 within the perimeter wall 14 when the clamping member 22 is in the closed position. The stationary lip 18 may have a half-dovetail profile. The clamping member 22 has an inward oriented overhang or “half dovetail” (FIGS. 3-5) to engage with a complimentary edge(s) 19a, 19b formed on workpiece 1 (see, e.g., FIG. 7) when the workpiece 1 is inserted onto the floor 16 of the securement member 12 to secure the workpiece 1 to the securement member 12.

In an example, the stationary lip 18, and complimentary edge(s) 19a, 19b, may have an angle of approximately 30 to 60 degrees. However, other profiles and angles of the stationary lip 18 or overhang may be provided. The stationary lip 18 ensures secure retention of the workpiece 1 while allowing for efficient positioning (e.g., within the triangular shaped perimeter wall 14). This angular overhang enhances the stability of the workpiece 1 by restricting unwanted movement and minimizing displacement forces during machining operations. The controlled overlap of the stationary lip 18 with the complimentary edge(s) 19a, 19b ensures that the workpiece 1 remains firmly seated under a predictable clamping force, reducing variability and increasing repeatability in precision applications.

The stationary lip 18 helps optimize mechanical interference between the stationary lip 18 and the complimentary edge(s) 19a, 19b of the workpiece 1, improving grip strength while maintaining accessibility. The angled configuration of the stationary lip 18 and complimentary edge(s) 19a, 19b enables a more effective engagement between the stationary lip 18 and the workpiece 1, particularly for applications requiring high resistance to vibrational forces and lateral shifts. The design prevents the workpiece 1 from slipping or rotating while accommodating variations in component geometry.

Additionally, the stationary lip 18 and complimentary edge(s) 19a, 19b on the workpiece 1 contributes to enhanced loading and unloading processes, allowing for easier insertion and removal of the workpiece 1 while maintaining a reliable hold. This feature is particularly beneficial in environments where frequent tool changes or part repositioning is required, providing a balance between secure retention and operational efficiency.

In an example, the universal workpiece holding device 10 includes an adjustable lip 24 of the clamping member 22 (see, e.g., FIGS. 3-6). The adjustable lip 24 further enhances a precision hold by the clamping member 22. The adjustable lip 24 on the clamping member 22 provides dynamic positioning, allowing for fine-tuned adjustments based on the dimensions and material properties of the workpiece 1. This flexibility ensures a firm and reliable hold, preventing unwanted movement during machining while accommodating variations in workpiece thickness or geometry.

The adjustable lip 24 functions as a secondary retention feature, interacting with the complimentary edge(s) 19a, 19b of the workpiece 1 to secure the workpiece 1 at least partially beneath its overhang as the clamping member 22 transitions from an open position to a closed position. This helps distribute holding forces more evenly across the workpiece 1, minimizing localized stress points and reducing the risk of distortion. The adjustable lip 24 enhances grip consistency and improves stability during different machining operations, supporting high-tolerance precision manufacturing.

In an example, the clamping member 22 has an inward oriented overhang or “half dovetail” (FIGS. 3-5) to also engage with a complimentary edge 19a, 19b formed on workpiece 1 (see, e.g., FIG. 7) when the workpiece 1 is inserted onto the floor 16 of the securement member 12 to secure the workpiece 1 to the securement member 12.

The adjustable lip 24 allows for easier workpiece 1 loading and unloading, making the universal workpiece holding device 10 suitable for applications requiring frequent part changes or reconfigurations. Operators can reposition the adjustable lip 24 to accommodate various components without needing to replace or modify the entire universal workpiece holding device 10. This feature significantly improves efficiency in machining environments, heavy equipment, robots, etc., reducing setup times while maintaining superior clamping force and repeatability. The adjustable lip 24, in combination with the securement member 22 and stationary lip 18, provides a comprehensive workholding solution optimized for precision machining.

In an example, the adjustable lip 24 can be any suitable shape and/or have any suitable profile. In an example, the adjustable lip 24 forms an angle of about 30 to 60 degrees relative to the floor 16. This angular configuration provides a strategic gripping advantage, ensuring secure retention of the workpiece 1 while allowing for controlled engagement.

The adjustable lip 18 enables the holding device to accommodate different workpiece geometries and surface finishes. The angled position ensures firm contact with the workpiece, improving grip strength and preventing unintended shifts during high-tolerance machining operations. This feature is especially beneficial for applications requiring precise positioning and controlled movement, as it provides a repeatable securing method that remains effective across various material types. The angular lip also facilitates better interaction with the workpiece 1, allowing for gradual pressure application when securing components. This design reduces excessive clamping forces, preserving the structural integrity of delicate or thin workpieces.

In an example, the universal workpiece holding device 10 also includes a fastener 26 and an opening 28 formed through the clamping member 22 to accommodate the fastener 26 and provide for movement of the clamping member 22 within opening 20 in the perimeter wall 14 (see, e.g., FIGS. 1-6). The fastener serves as the primary mechanism for transitioning the clamping member 22 between the open and closed positions and maintaining the clamping member 22 in the closed or secured position. This configuration ensures that the fastener effectively manipulates the clamping member without introducing unnecessary play or misalignment, while maintaining a rigid and predictable interface between components. This structural feature facilitates ease of use, ensuring that operators can efficiently secure and release the workpiece 1 as needed.

In an example, the universal workpiece holding device 10 has a threaded opening 30 formed in the securement member 12. FIG. 1A corresponding unthreaded opening is formed through the clamping member 22. At least one set screw 26 is provided and is receivable through the unthreaded opening 28 in the clamping member 22 and into the threaded opening in the securement member 12. The set screw 26 is operable (e.g., rotatable) to tighten and loosen the at least one clamping member 22 in the securement member 12.

In an example, the fastener 26 engages within the securement member 12 in a threaded opening 30 formed beneath the floor 16. By positioning the engagement point under the floor 16, the design reinforces structural integrity and enhances load distribution, ensuring that the clamping force remains consistent across various workpiece sizes and materials. This lower engagement interface also improves overall rigidity, preventing unintended loosening or disengagement under dynamic machining conditions.

In an example, the universal workpiece holding device 10 includes a spring member 32 (see, e.g., FIGS. 1-2 and 5-6). Any suitable spring may be provided. The example spring member 32 shown in the drawings consists of a plurality of stacked, interconnected spring washers. The spring member 32 is positioned around the shaft of the fastener 26, ensuring consistent pressure is applied to the workpiece even as machining forces fluctuate. The spring member 32 ensures that the clamping member 22 transitions smoothly between open and closed positions while maintaining a secure grip. This functionality supports high-tolerance machining by optimizing retention strength while allowing for controlled movement when necessary.

In an example, the spring member 32 is configured to push the clamping member 22 open to allow for loading of a workpiece 1. In another example, the spring member 32 is for inserting between the securement member 22 and the workpiece 1 to provide tension on the workpiece 1 being held by the securement member 22. The spring member 32 may also be provided between two adjacent securements members. In another example, the universal workpiece holding device can be automated (e.g., via pneumatics or hydraulics, or even an electric motor) to force open the clamping member 22. In this example, the spring member 32 also holds the clamping member 22 in the closed position.

In addition, the spring member 32 can reduce backlash and prevent unintended loosening of the clamping member 22. The spring member 32 also allows for dynamic force adjustment, enabling the clamping member 22 to accommodate variations in material properties, thermal expansion, or external vibrations. As machining progresses, the spring member 32 absorbs minor shifts, ensuring that the fastener remains engaged with the workpiece while mitigating excess stress. This elasticity improves workpiece stability without requiring manual recalibration, streamlining machining operations for efficiency and precision.

In an example, the clamping member 22 is shaped to complement the shape of the opening 20 formed through the perimeter wall 14 (see, e.g., FIGS. 1 and 3-4). This complementary design ensures a precise and secure fit, minimizing unwanted movement while optimizing workpiece stability and maintaining tight tolerances between the clamping member 22 and its corresponding opening 20. The shape of the clamping member 22 is engineered to align with the opening 20 of the perimeter wall 12, creating a seamless interface that prevents lateral or rotational shifts. This precise fit reduces potential play between the components, ensuring that the clamping force is evenly distributed across the workpiece. The controlled engagement improves grip reliability and prevents deviations that could affect machining tolerances, particularly in applications requiring micron-level precision.

In an example, the clamping member 22 has distinct width variations to optimize stability and retention (see, e.g., FIGS. 3 and 4). The clamping member 22 is shown for example, as it may include a body portion with a first maximum width (W1), providing a broad base for secure engagement with the securement member 12. This increased width enhances structural rigidity, ensuring that the clamping force is evenly distributed across the workpiece. The body portion supports robust gripping while minimizing potential movement during high-precision machining operations.

Above the body portion, the clamping member 22 transitions into a neck portion with a second maximum width (W2), positioned between the body portion and the top of the clamping member 22. This neck portion has a greater width than the body portion, reinforcing mechanical strength while facilitating controlled force application. The neck and body geometry contributes to a balanced holding mechanism, preventing undesired up and down movement. The width (W2) of the neck portion of the clamping member is narrower than the width (W1) of the body portion. The combination of these width variations ensures that the clamping member securely engages with the securement member, providing a stable retention system.

In an example, the clamping member 22 has a lower portion and neck portion that are substantially pear-shaped. This distinctive shape provides a broader base at the lower portion, ensuring enhanced gripping strength and secure engagement with the securement member. By incorporating a pear-shaped profile, the clamping member 22 minimizes unwanted movement and improves load distribution, preventing stress concentration on the workpiece 1.

The tapered transition between the body and neck portions of the clamping member 22 enables controlled force application while maintaining a tight fit within the opening 20 of the perimeter wall 14. The widened base increases mechanical resistance against lateral and rotational shifts, while the narrower upper portion facilitates precise insertion and alignment. Its structural design ensures predictable engagement with the securement member 12, reducing backlash and improving stability during machining operations.

In an example, the perimeter wall 14 has distinct outside height (H1) and inside height (H2) measurements (see, e.g., FIG. 6). The outside height (H1) is measured from the top of the perimeter wall 14 (e.g., the top of stationary lip 18) to the lower portion of the perimeter wall 14. This external dimension (H1) provides reinforcement to the overall structure, enhancing rigidity and stability during machining operations. By extending beyond the level of the internal floor 16, the perimeter wall 14 provides increased support and resistance against external forces, reducing potential deformations caused by cutting or clamping pressures.

The inside height (H2) is defined as the vertical distance between the top of the perimeter wall 14 (e.g., the top of stationary lip 18) and the floor 16 of the securement member 12 (i.e., the depth available for placement of the workpiece 1). This internal measurement governs the amount of clearance the workpiece 1 has when positioned within the device 10, ensuring secure and controlled engagement. The design of the inside height (H2) maintains a balance between accessibility and firm retention, preventing unintended shifts while allowing for efficient insertion and removal of the workpiece 1.

The outside height (H1) is greater than the inside height (H2), reinforcing the structural integrity of the perimeter wall while providing additional containment. This dimensional difference ensures that the external boundary of the securement member 12 remains robust, absorbing mechanical stress and protecting the workpiece 1 from excessive external vibrations or lateral forces. The elevated outer perimeter wall 14 contributes to improved rigidity, making the workpiece holding device 10 more resilient to machining-induced loads. Through this height differential, the universal workpiece holding device 10 enhances precision machining performance by maintaining stability of the workpiece 1.

In an example, the perimeter wall 14 has a substantially triangular shape (see, e.g., FIGS. 1 and 6). This provides a stable and rigid structural framework for securing a workpiece 1 therebetween. The geometric structure minimizes flexing and unwanted movement, ensuring that the workpiece 1 remains securely positioned throughout high-precision machining operations. This triangular configuration also enhances overall strength and resistance to machining forces by distributing load evenly across its three sides.

In an example, the stationary lip 18 is integrated along at least a portion of the first and second sides of the triangular shaped perimeter wall 14, functioning as a restraining mechanism to hold the workpiece in place. The stationary lip 18 along two sides enables positioning of the workpiece 1 therein, with the clamping member 22 applying a closing force from the third side of the triangular shaped perimeter wall 14, provides dual reinforcement, improves grip consistency, and maintains accessibility for adjustments to the workpiece 1.

In another example, the universal workpiece holding device 10 has two or more clamping members 10 and 100, as shown by way of illustration in FIG. 8. Each clamping member 10 and 100 is strategically positioned to provide distributed holding force on a workpiece 1, ensuring that machining forces do not cause unintended shifts or misalignment. By including multiple clamping elements, the universal workpiece holding device 10 accommodates various workpiece sizes and geometries, optimizing retention across different machining applications while maintaining repeatable accuracy. The interaction between the openings and clamping members provides a controlled engagement mechanism, allowing secure locking and predictable adjustments based on workpiece requirements. The integration of multiple clamping members 10 and 100 enhances the adaptability of the workpiece holding device. This design facilitates secure retention of large or irregularly shaped workpieces 1, enabling operators to apply different levels of force across multiple engagement points. The additional clamping members 10 and 100 provide a more uniform distribution of holding pressure, improving grip strength while minimizing localized stress.

In an example, the securement member 100 has a dual perimeter wall structure, including a first perimeter wall 114a and a second perimeter wall 114b for engaging a complimentary edge 19b a workpiece 1 (see, e.g., FIGS. 8 and 9). These walls 114a, 114b are positioned apart from one another and run parallel to each other, creating a defined channel with floor 116 for accommodating and securing a workpiece 1. The parallel alignment of the walls 114a, 114b ensures enhanced stability, reinforcing the structural integrity of the securement member 100 while allowing for precise clamping adjustments, e.g., by sliding the workpiece 1 therebetween to the desired position before clamping. A stationary lip 118a, 118b is formed along at least a portion of both the first and second perimeter walls 114a, 114b, respectively, serving as the retention feature already described above. Additionally, the dual perimeter wall structure of securement member 100 enhances adaptability by accommodating various workpiece sizes and shapes.

In an example, a straight workpiece holding device 100 can be utilized in conjunction with a fixed workpiece holding device 10 to permit adjustments and/or movement and/or accommodate larger workpieces (see, e.g., FIGS. 7-9). This setup enables controlled positioning changes, allowing the workpiece 1 to be repositioned without complete disengagement from the workpiece holding device 10. Such a configuration can be beneficial in operations where progressive adjustments are needed during multi-stage machining processes.

In an example, the securement member(s) 10 and 100 can be machined as part of or otherwise mounted onto a base member 5, enhancing structural stability and adaptability for various machining applications. The base member 5 serves as a foundational platform that supports the securement member(s) 10 and 100, ensuring that the workpiece 1 remains firmly positioned throughout machining operations. The inclusion of base member 5 provides added structural integrity while facilitating efficient and secure clamping for precision machining applications.

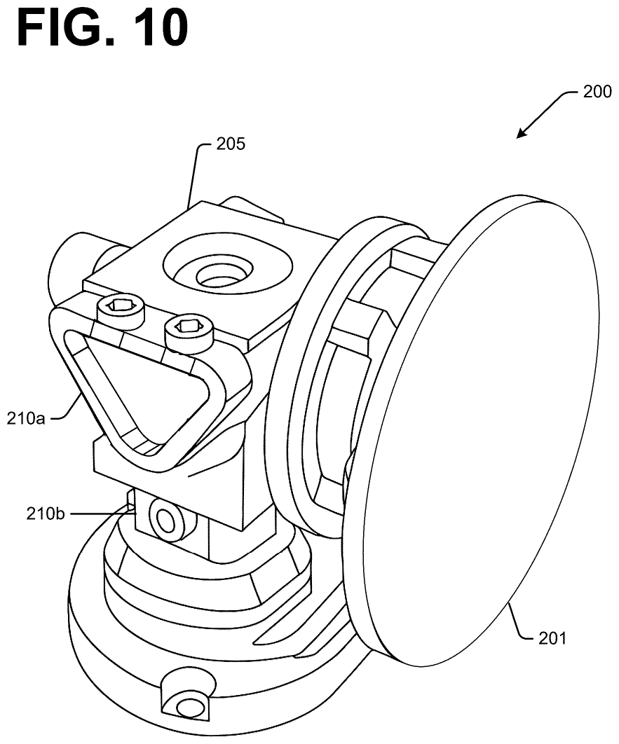

FIG. 10 is an isometric view of example universal workpiece holding devices as these can be connected together to form any of a variety of different systems 200. In an example, the universal workpiece holding device can be integrated into a mounting system 200 including other securement member(s), workpieces, base members, etc. This aspect enables modular setups with a variety of components and/or flexible installation on a variety of machine tables, rotary platforms and other devices. This adaptability enhances the versatility of the universal workpiece holding device across different machining environments, ensuring compatibility with a wide range of workpieces and production requirements.

In an example, the universal workpiece holding device is configured as a multi-component securement system 200 having at least a first securement member 210a and a second securement member 210b. Any number of securement members may be implemented for the multi-component securement system 200. In addition, there is no limit to the type and/or arrangement of securement members that may be implemented.

In an example operation, a base member 205 the first securement member 210a is positioned onto the floor of the second securement member 210b beneath the stationary lip of the second securement member 210a when its clamping member is in the open position. Once inserted, the clamping member of the second securement member 210b transitions into the closed position, pressing against the first securement member 210a to secure it firmly beneath the stationary lip. This arrangement ensures a stable connection between the two securement members 210a and 210b, minimizing unwanted movement while providing a controlled retention mechanism for high-precision machining.

Similarly, a workpiece 201 can also be attached to another securement member (not visible in FIG. 10) inserted onto the floor of the securement member when the clamping member is in the open position. As the clamping member moves into the closed position, it presses against the workpiece, securing it at least partially beneath the stationary lip of the first securement member 210a. This securement approach ensures consistent retention of the workpiece 201. By integrating multiple securement members, the multi-component securement system 200 enhances stability and adaptability, supporting precision machining applications that demand high accuracy and repeatable clamping performance.

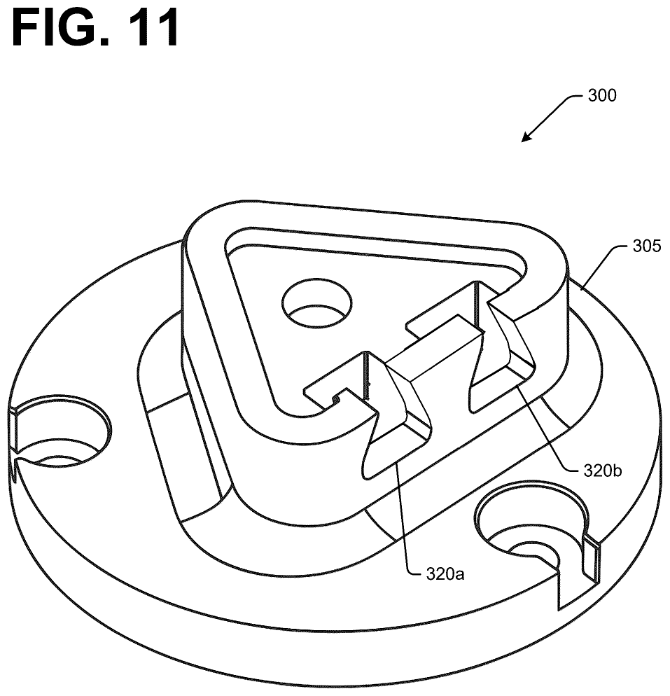

FIG. 11 is an isometric view of another example universal workpiece holding device 300. The universal workpiece holding device 300 has two openings 320a, 320b for two clamping members (not shown in FIG. 11).

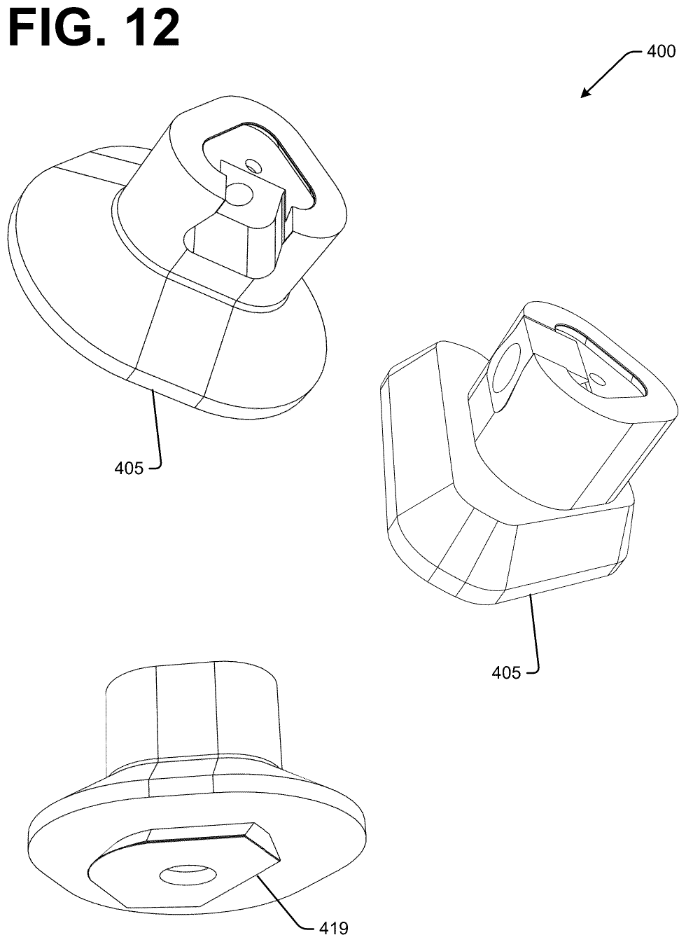

FIG. 12 is an isometric view of another example universal workpiece holding device 400. FIG. 13 shows top and side views of the example universal workpiece holding device shown in FIG. 12. This configuration is similar to that shown in FIG. 1 except that the base 405 is triangular shaped so that it can be configured to sit on top of another universal workpiece holding device (e.g., device 10 shown in FIG. 1). Also visible in FIG. 12 is the complimentary edge 419 for interconnecting universal workpiece holding device 400 to another universal workpiece holding device (not shown in FIG. 12).

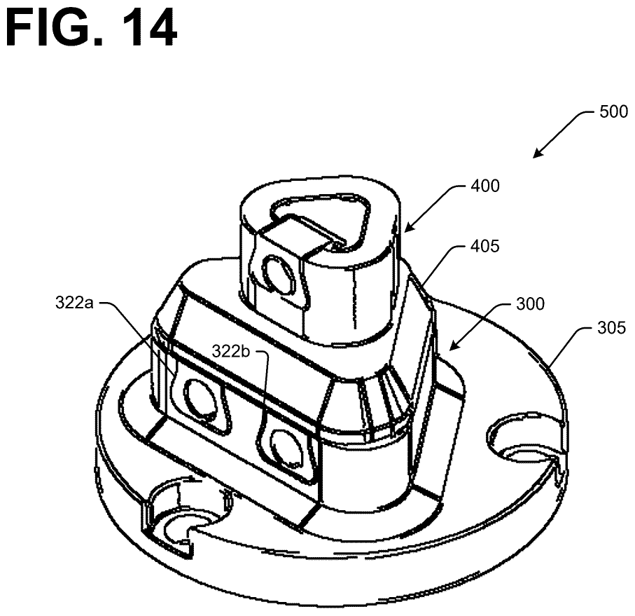

FIG. 14 is an isometric view of another example universal workpiece holding device 500. The universal workpiece holding device 500 is shown as it may include the universal workpiece holding device 400 (FIGS. 12 and 13) together with universal workpiece holding device 300 (FIG. 11). It is noted that clamping members 322a, 322b are shown in FIG. 14 as these may be inserted into openings 320a, 320b, respectively to secure the universal workpiece holding device 400 to the universal workpiece holding device 300.

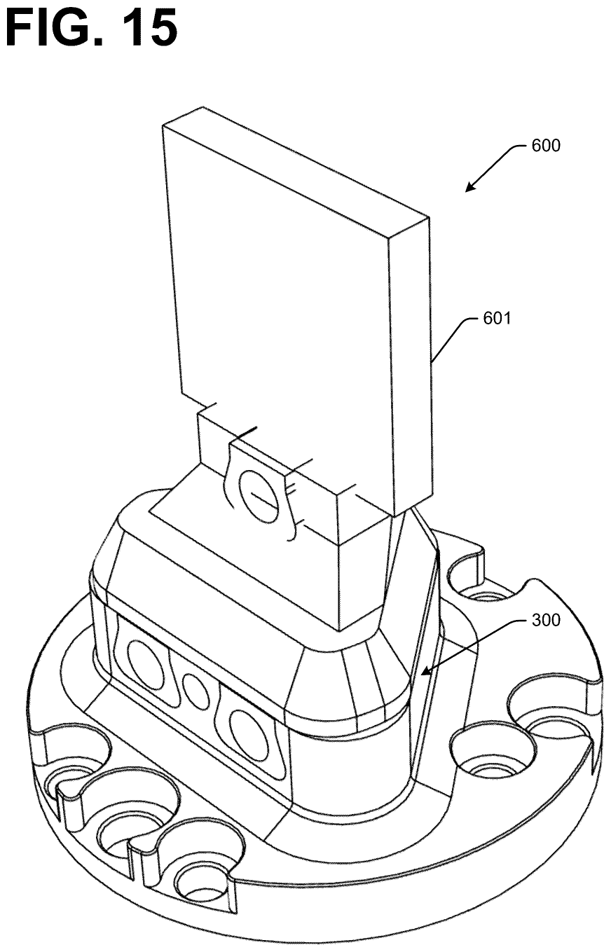

FIG. 15 is an isometric view of another example universal workpiece holding device 600. The universal workpiece holding device 600 includes universal workpiece holding device 300 (FIG. 11) and a workpiece 601.

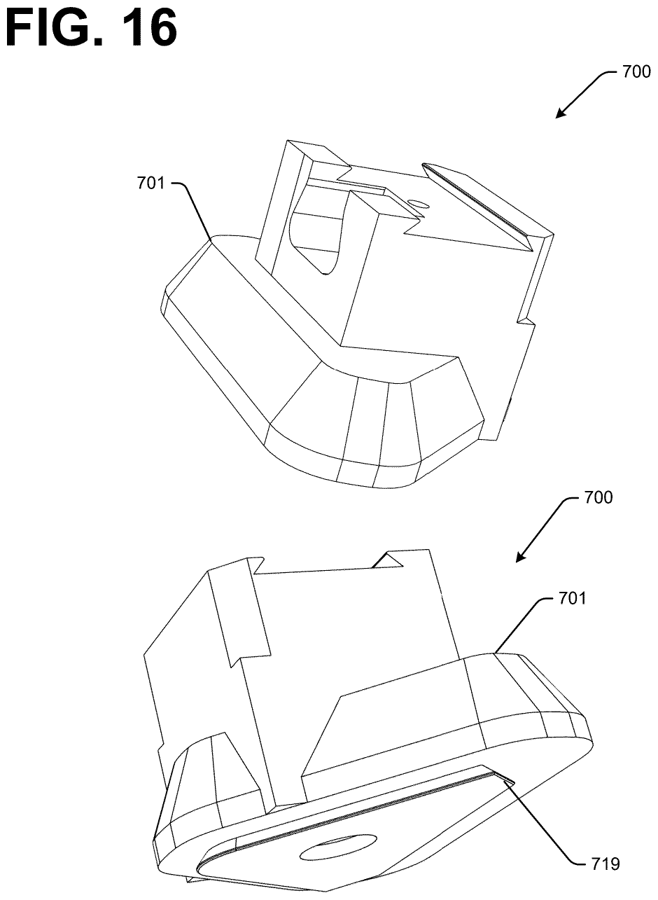

FIG. 16 shows isometric views of another example universal workpiece holding device 700. The universal workpiece holding device 700 has a parallel perimeter configuration similar to the configuration of universal workpiece holding device 100 shown in FIG. 8. The universal workpiece holding device 700 includes a base 701 and complimentary edge 719 similar to that already described above for FIG. 7.

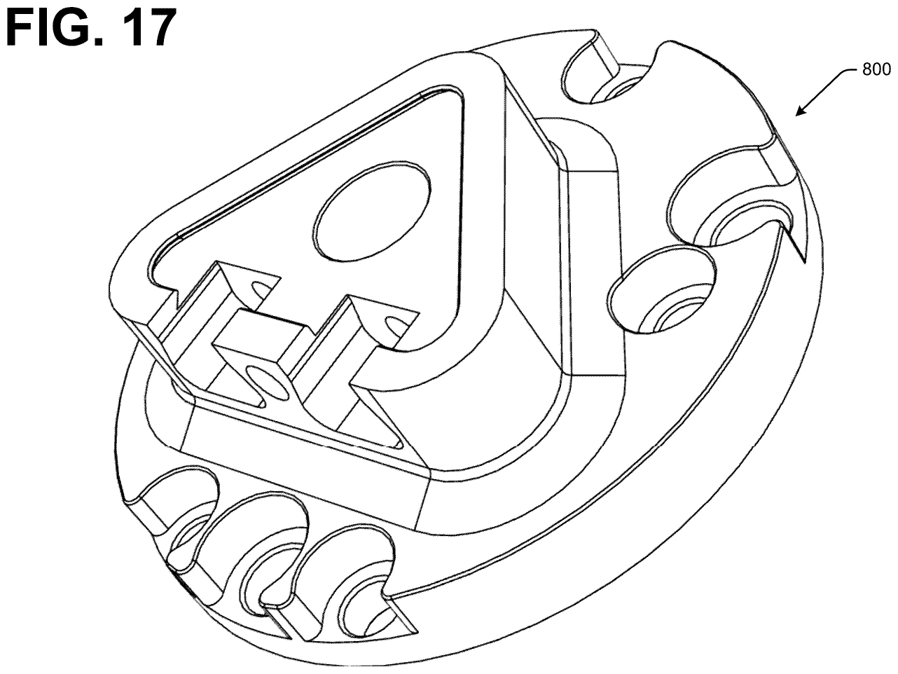

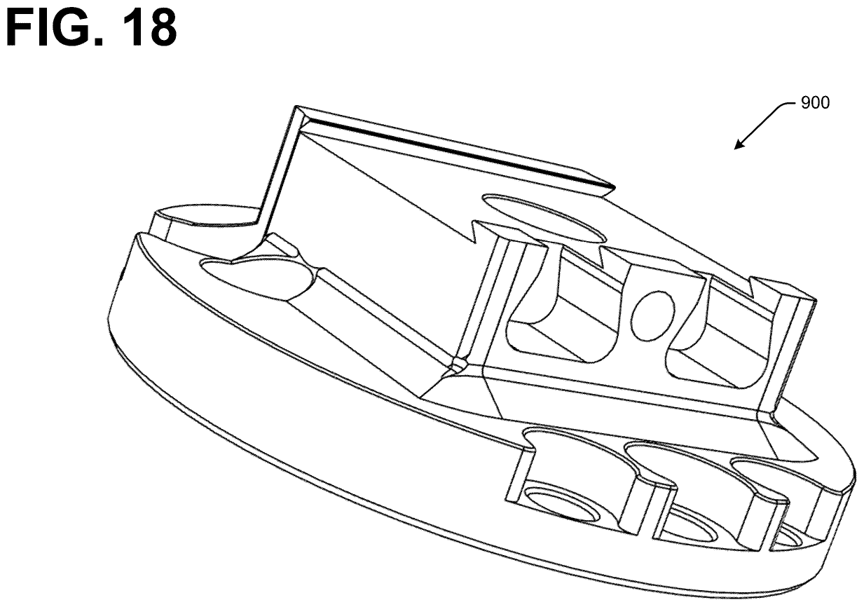

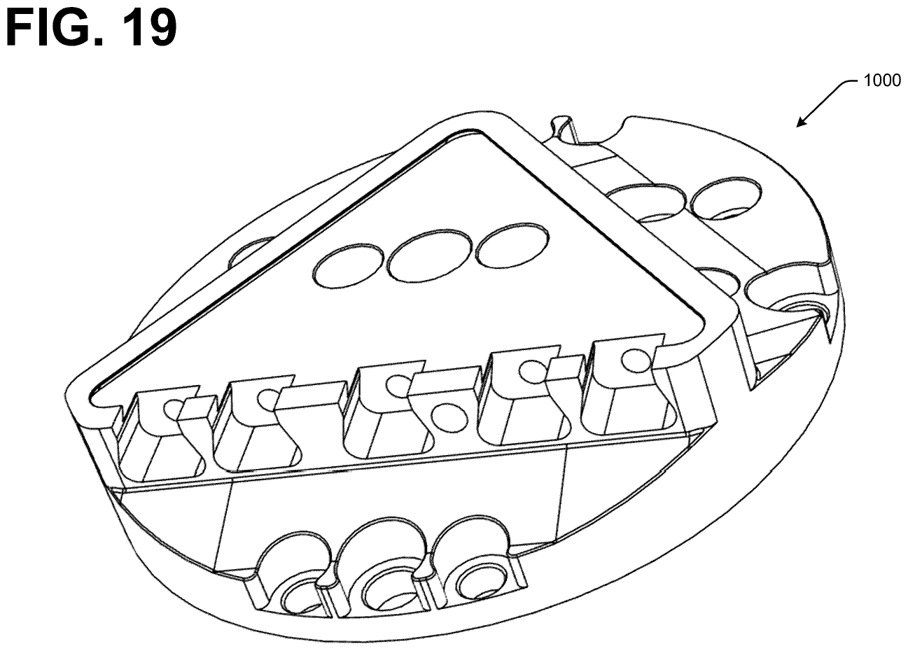

FIG. 17 is an isometric view of another example universal workpiece holding device 800 having a different configuration but similar elements as already described above. FIG. 18 is an isometric view of another example universal workpiece holding device 900 having a different configuration but similar elements as already described above. FIG. 19 is an isometric view of another example universal workpiece holding device 1000.

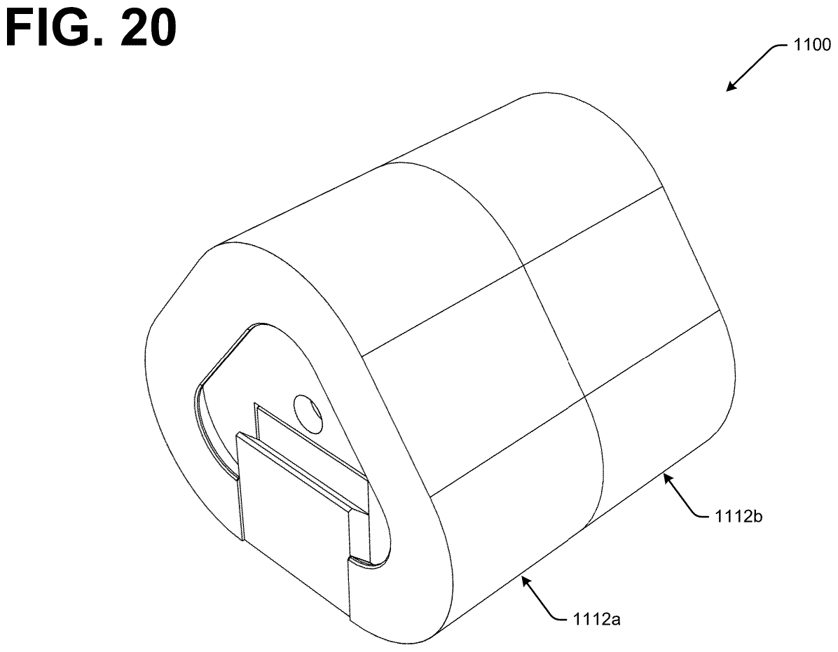

FIG. 20 is an isometric view of another example universal workpiece holding device 1100. The universal workpiece holding device 1100 having two securement elements 1112a and 1112b interconnected to one another according to the interconnection mechanism already described above.

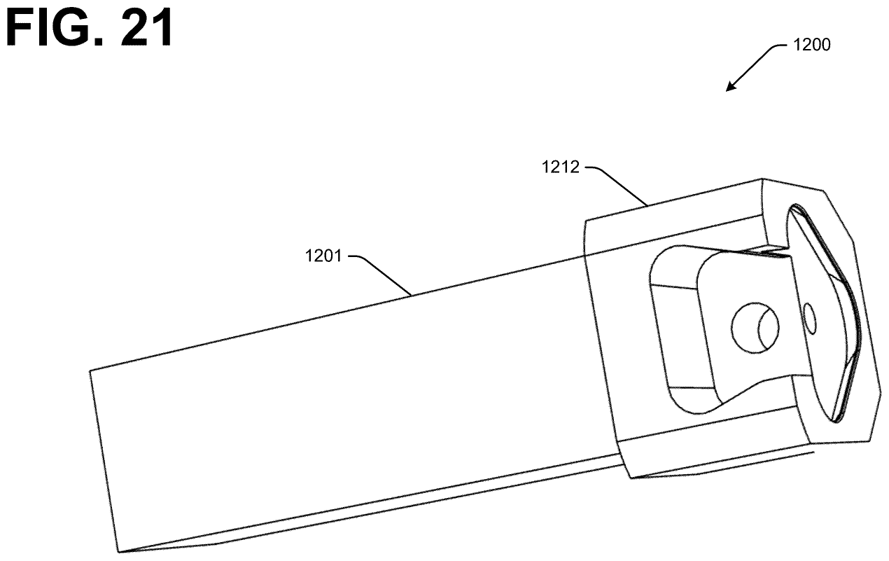

FIG. 21 is an isometric view of another example universal workpiece holding device 1200. The universal workpiece holding device 1200 includes the workpiece 1201 integral with (e.g., formed as part of, welded or otherwise connected thereto) a securement element 1212.

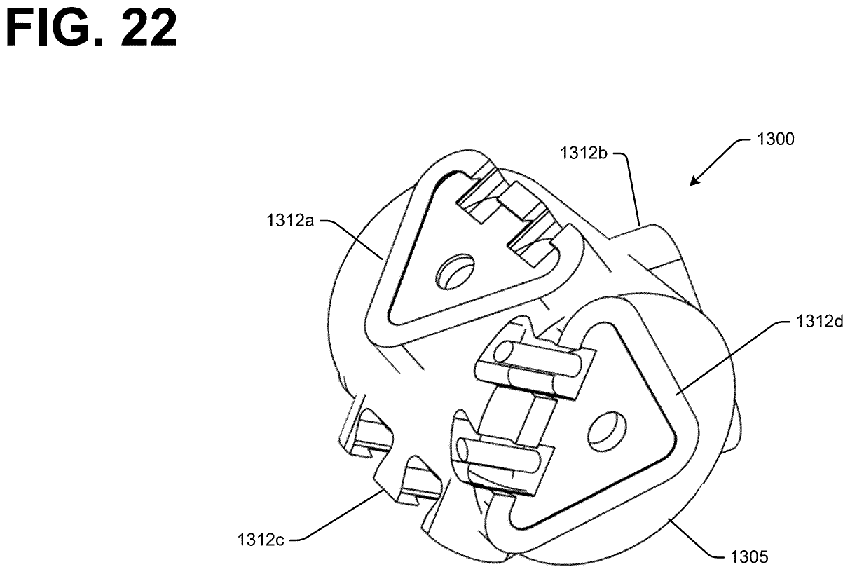

FIG. 22 is an isometric view of another example universal workpiece holding device 1300. The universal workpiece holding device 1300 has a cylindrical shaped body 1305 with variously configured triangular securement elements 1312a-d thereon.

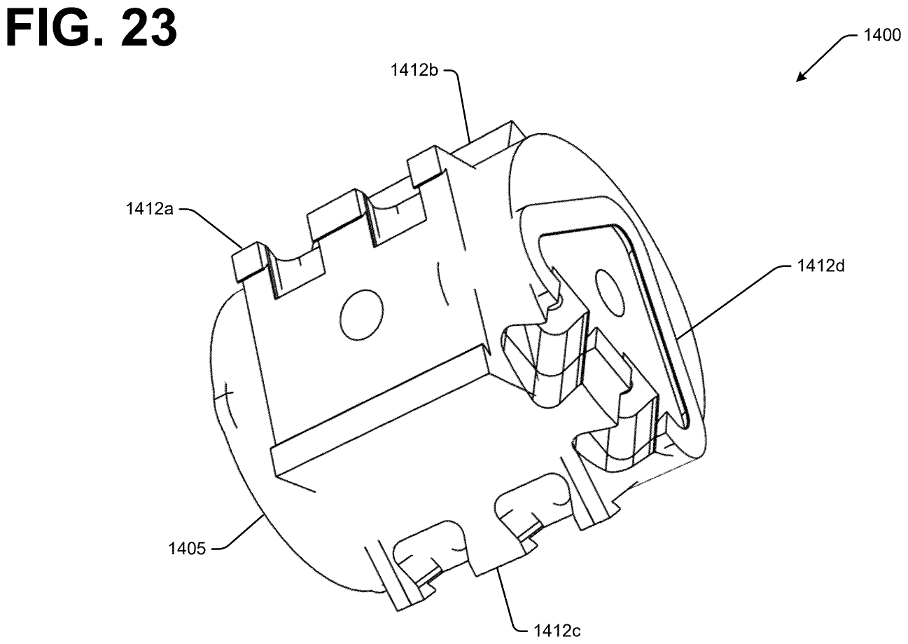

FIG. 23 is an isometric view of another example universal workpiece holding device 1400. The universal workpiece holding device 1400 has a cylindrical shaped body 1405 with variously configured securement elements 1412a-d thereon. The securement elements 1412a-d have a generally rectangular shape with parallel walls forming the lip or overhang for mounting workpieces and/or other securement elements thereto.

It is noted that the examples shown and described are provided for purposes of illustration and are not intended to be limiting. Still other examples are also contemplated.

1. A universal workpiece holding device for holding a workpiece during a precision machining process, the device comprising:
a securement member;
a perimeter wall of the securement member forming a floor on the securement member within the perimeter wall;
a stationary lip formed around at least a portion of an inside of the perimeter wall, the stationary lip partially overhanging the floor within the perimeter wall;
at least one opening formed through the perimeter wall; and
at least one clamping member configured to slide into at least one opening formed through the perimeter wall between an open position and a closed position;
wherein the workpiece is inserted onto the floor of the securement member under the stationary lip formed around at least a portion of an inside of the perimeter wall when the at least one clamping member is in the open position, and the at least one clamping member is moved into the closed position against the workpiece to secure the workpiece to the securement member at least partially under the stationary lip.

2. The universal workpiece holding device of claim 1, wherein the stationary lip partially overhangs the floor within the perimeter wall forming a half-dovetail joint at an angle of between about 30 degrees and 60 degrees.

3. The universal workpiece holding device of claim 1, further comprising an adjustable lip on the at least one clamping member, wherein the workpiece is secured to the securement member at least partially under the adjustable lip.

4. The universal workpiece holding device of claim 1, wherein the adjustable lip forms a half-dovetail joint having an angle of between about 30 degrees and 60 degrees relative to the floor when the at least one clamping member is in the closed position.

5. The universal workpiece holding device of claim 1, further comprising:
a fastener for the at least one clamping member;
wherein an opening is formed through the at least one clamping member for receiving the fastener therethrough; and
wherein the fastener engages with the securement member to move the at least one clamping member into the closed position.

6. The universal workpiece holding device of claim 5, wherein the fastener engages into the securement member under the floor.

7. The universal workpiece holding device of claim 1, further comprising a spring member configured to fit around a shaft of the fastener between the at least one clamping member and the securement member.

8. The universal workpiece holding device of claim 1, wherein a shape of the at least one clamping member is complementary to a shape of the at least one opening formed through the perimeter wall so that the at least one clamping member fits into the at least one opening formed through the perimeter wall with a tight tolerance.

9. The universal workpiece holding device of claim 8, wherein the at least one clamping member has a body portion with a first maximum width (W1) and a neck portion with a second maximum width (W2), wherein the first maximum width (W1) is greater than the second maximum width (W2).

10. The universal workpiece holding device of claim 9 wherein the lower portion and the neck portion of the at least one clamping member is substantially pear shaped.

11. The universal workpiece holding device of claim 1, wherein the perimeter wall of the securement member has an outside height (H1) measured between the stationary lip and a lower portion of the perimeter wall, and the perimeter wall of the securement member has an inside height (H2) measured between the stationary lip and the floor, and wherein the outside height (H1) is greater than the inside height (H2).

12. The universal workpiece holding device of claim 1, wherein perimeter wall of the securement member has a substantially triangular shape, and the stationary lip is formed along at least a portion of the first side and the second side of the triangular shape, and the at least one opening is formed through the perimeter wall in the third side of the triangular shape.

13. The universal workpiece holding device of claim 1, wherein perimeter wall of the securement member is formed as a first perimeter wall and a second perimeter wall, the first perimeter wall positioned apart and parallel to the second perimeter wall, and the stationary lip is formed along at least a portion of the both the first perimeter wall and the second perimeter wall.

14. The universal workpiece holding device of claim 1, further comprising two or more clamping members and two or more corresponding openings formed through the perimeter wall.

15. The universal workpiece holding device of claim 1, wherein the securement member is provided on a base member.

16. A universal workpiece holding device for holding a workpiece during a precision machining process, the device comprising:
a first securement member and a second securement member, each securement member having:
a perimeter wall of the securement member forming a floor on the securement member within the perimeter wall;
a stationary lip formed around at least a portion of an inside of the perimeter wall, the stationary lip partially overhanging the floor within the perimeter wall;
at least one opening formed through the perimeter wall; and
at least one clamping member configured to slide into at least one opening formed through the perimeter wall between an open position and a closed position;
wherein the first securement member is inserted onto the floor of the second securement member under the stationary lip formed around at least a portion of an inside of the perimeter wall of the second securement member when the at least one clamping member of the second securement member is in the open position, and the at least one clamping member of the second securement member is moved into the closed position against the first securement member to secure the first securement member to the second securement member at least partially under the stationary lip of the second securement member; and
wherein the workpiece is inserted onto the floor of the first securement member under the stationary lip formed around at least a portion of an inside of the perimeter wall of the first securement member when the at least one clamping member of the first securement member is in the open position, and the at least one clamping member of the first securement member is moved into the closed position against the workpiece to secure the workpiece to the first securement member at least partially under the stationary lip of the first securement member.

17. The universal workpiece holding device of claim 16, wherein perimeter wall of at least one of the first and second securement members has a substantially triangular shape, and the stationary lip is formed along at least a portion of the first side and the second side of the triangular shape, and the at least one opening is formed through the perimeter wall in the third side of the triangular shape.

18. The universal workpiece holding device of claim 16, wherein perimeter wall of at least one of the first and second securement members is formed as a first perimeter wall and a second perimeter wall, the first perimeter wall positioned apart and parallel to the second perimeter wall, and the stationary lip is formed along at least a portion of the both the first perimeter wall and the second perimeter wall.

19. The universal workpiece holding device of claim 16, further comprising two or more clamping members and two or more corresponding openings formed through the perimeter wall of at least one of the first and second securement members.

20. The universal workpiece holding device of claim 16, wherein at least one of the first and second securement members is provided on a base member.
